(19) United States
(12) Patent Application Publication
(10) Pub. No.: US 2013/0309954 A1
(43) Pub. Date: Nov. 21, 2013

(54) OPERATING DEVICE FOR A DOOR IN AN AIR CONDITIONING SYSTEM

(71) Applicant: Bjoern LINDNER, Schiltach (DE)

(72) Inventors: Bjoern LINDNER, Schiltach (DE); James MACMILLAN, Rochester, MI (US)

(21) Appl. No.: 13/474,249

(22) Filed: May 17, 2012

(51) Int. Cl. B60H 1/34

(52) U.S. Cl. 454/152

(57) ABSTRACT

An operating device for a door in an air conditioning system is provided that includes a latching system to close and open the door and a spring to assist the latching system. By an operating device for a door in an air conditioning system which allows a simple activation of the door with minimal electrical interface the latching system is powered in one direction wherein the latching system can engage two different positions which corresponds with two positions of the door.

### BACKGROUND OF THE INVENTION

1. Field of the Invention

The invention refers to an operating device for a door in an air conditioning system. The operating device comprises a latching system to close and open the door and a spring to assist the latching system.

2. Description of the Background Art

Air conditioning systems in motor vehicles have doors to switch between fresh air and recirculation air. These doors are operated by an actuator. The door can engage different positions if desired by the passenger of the motor vehicle. To support the actuations of the actuator an electronic overhead is necessary. Furthermore, a lot of software is necessary to control the door in said different positions. Hence, such an actuator is very expensive.

DE 103 01 798 A1 discloses an actuator for controlling the doors of an air conditioning systems comprising a latching system and a spring. The latching system contains an SMA (Shape Memory Alloy) element, which changes its expansion by heating. Consequently, the latching system can engage different positions.

### SUMMARY OF THE INVENTION

A problem addressed in an embodiment of the invention is to indicate an operating device for a door in an air conditioning system which allows a simple activation of the door with minimal electrical interface.

In an embodiment, the latching system is powered in only one direction wherein the latching system could engage two different positions which corresponds to the two positions of the door. This embodiment shows a simple mechanical device with a minimal electric interface and only two positions, a latched position and an unlatched position. The door of the air conditioning system driven by the operating device can engage two positions which correspond to the two positions of the latching system. An electronic overhead with software interfaces to position the door is not required. Consequently, such an operation device is very cheap producible.

In addition, the latching system comprises a fixed part and a pivotable part wherein the pivotable part is engaged in two different adapters located in varied heights of axial expansion of the fixed part. The door connected to the latching system is positioned in different positions depending on the adapter, in which the pivotable part is landed.

In another aspect of the invention, a pinion located in the centre of the fixed part of said latching system is axial moved to switch the latching system between said first and said second adapter. Hence, the operating device operates like a pen wherein only the pinion has to be activated to change between the two positions of latching system.

Furthermore, during the latched position of latching system the pivoted part is fixed in the first adapter of the fixed part. In this way the pivotable part is mechanically hold without any electrical means.

In addition, the pivotable part is reset due to the restoring force of the spring during further activation of said pinion. The mechanical embodiment allows a very cost-effective solution.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a first embodiment of operating device according to the invention;

FIG. 2 illustrates a schematic diagram of operating mode of operating device according to FIG. 1; and

FIG. 3 illustrates schematic diagram for operating mode of pivotable part according to the invention,

### DETAILED DESCRIPTION

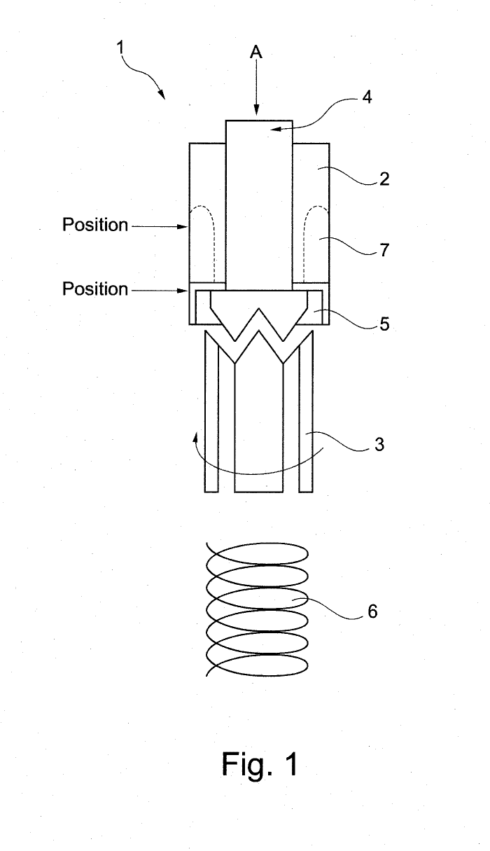

FIG. 1 shows a first embodiment of an operating device for a door in an air conditioning system according to the invention. The door is engaged in the air conditioning system to switch between fresh air channel and recirculation air channel. To reach two positions of the door the operating device is constructed as latching system 1. This latching system 1 includes two separate parts, a fixed part 2 and a pivotable part 3. In the fixed part 2 a pinion 4 is located centrically wherein on the side of the fixed part 2 which lies vis-à-vis to the pivotable part 3 an first adapter 5 is formed. A second adapter 7 is positioned in another high inside the fixed part 2. The pivotable part 4 is enclosed by a return spring 6.

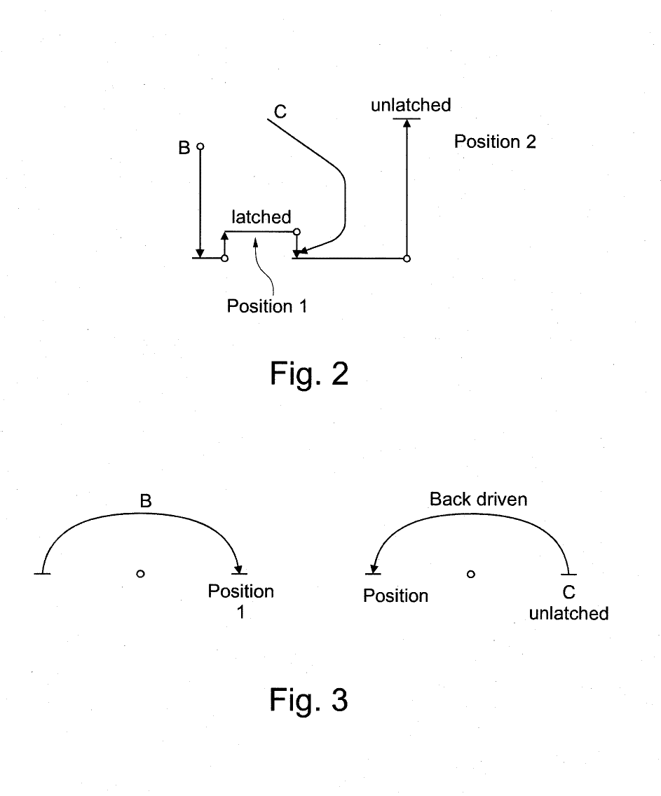

The operation mode of latching system 1 should be explained by FIG. 2. The latching system 1 is activated by moving the pinion 4 in an axial direction (arrow A in FIG. 1). During the first activation B the pivotable part 3 of the latching system 1 engages with the first adapter 5 of the fixed part 2 of the latching system 1 which depicts a first position of the latching system which correlates with the first door position of the air conditioning system.

During a second activation C of the pinion 4, which again moves in the same axial direction of arrow A the pivotable part 4 of the latching system 1 leaves the adapter 5 and is back driven to the second adapter 7 in the second position wherein it rotates into the fixed part 2. The resetting takes place as result of the force of the return spring 6. Hence, the latching system 1 takes up in a second position which corresponds to the second position of the door of the air conditioning system.

The rotation of the pivotable part 3 is depicted in FIG. 3. FIG. 3a shows the first activation B of pinion 4, where the pivotable part 3 is rotated into the latched position of latching system 1. During second activation C of pinion 4 the pivotable part 3 is unlatched. The return spring 6 moves the pivotable part 3 back in the second position.

It have to be secured that the pinion 4 is capable of being back driven (activation C) wherein the pinion 4 overlaps the fixed part 2 more than by activation B.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An operating device for a door in an air conditioning system, comprising
a latching system configured to close and open the door; and
a spring configured to assist the latching system;
wherein the latching system is powered in one direction, and
wherein the latching system is configured to engage two different positions which corresponds with two positions of the door.

2. The operating device according to claim 1, wherein said latching system comprises a fixed part and a pivotable part, and wherein the pivotable part is engaged in two different adapters located in varied heights of axial expansion of the fixed part.

3. The operating device according to claim 2, wherein a pinion located in the centre of the fixed part of the latching system and is axial moved to switch the latching system between the two different adapters.

4. The operating device according to claim 2, wherein the pivoted part is fixed in a first position in the first adapter of the fixed part.

5. The operating device according to claim 4, wherein the pivotable part is reset due to a restoring force of the spring during activation of the pinion.
